(19) United States
(12) Patent Application Publication
(10) Pub. No.: US 2026/0140599 A1
(43) Pub. Date: May 21, 2026

(54) IN-VEHICLE DISPLAY CONTROL DEVICE, IN-VEHICLE DISPLAY CONTROL METHOD, AND RECORDING MEDIUM

(71) Applicant: Panasonic Automotive Systems Co., Ltd., Kanagawa (JP)

(72) Inventors: Hiroyuki HAYASHI, Kanagawa (JP); Nobutaka KITAJIMA, Osaka (JP); Shintaro TSUBATA, Ishikawa (JP)

(73) Assignee: Panasonic Automotive Systems Co., Ltd., Kanagawa (JP)

(21) Appl. No.: 19/364,263

(22) Filed: Oct. 21, 2025

(30) Foreign Application Priority Data
Nov. 15, 2024 (JP) 2024-199920

(51) Int. Cl. G06F 3/0482; G06F 3/04886; G06F 3/14

(52) U.S. Cl. CPC G06F 3/0482; G06F 3/04886; G06F 3/1423; G06F 2203/04803

(57) ABSTRACT

An in-vehicle display control device that controls a display device included in a vehicle, including: an obtainer that obtains candidate information that is a candidate for display on a display screen of the display device; and a display controller that causes visibility options to be displayed on the display screen, and causes the candidate information obtained by the obtainer to be displayed on the display screen when displaying the candidate information onto the display screen is selected in the visibility options, the visibility options being options of displaying or not displaying the candidate information onto the display screen.

### CROSS REFERENCE TO RELATED APPLICATION

The present application is based on and claims priority of Japanese Patent Application No. 2024-199920 filed on November 15, 2024.

### FIELD

The present disclosure relates to an in-vehicle display control device included in a vehicle, an in-vehicle display control method, and a recording medium.

### BACKGROUND

In recent years, there have been known devices that are capable of dividing the display region of a display screen into a plurality of regions and changing the layout of the divided regions. For example, Patent Literature (PTL) 1 discloses an information controlling device including: a display region setting unit that sets the current layout of a divided region to another layout or to a full-screen region, which is the entire display screen serving as a single display region, on the basis of an operation performed on a first object located on an intersecting point on border lines that divide the display region on the display screen into a plurality of regions; and a display information generation unit that generates display information to be displayed in the display region. This information controlling device sets the layout of a divided region that includes a region change mark on which a touch operation has been received to a layout in which such divided region is displayed in an enlarged manner.

### Citation List

### Patent Literature

PTL 1: Japanese Patent No. 7252045

### SUMMARY

However, the information controlling device according to PTL 1 can be improved upon.

In view of this, the present disclosure provides an in-vehicle display control device and so forth capable of improving upon the above related art.

An in-vehicle display control device according to an aspect of the present disclosure is an in-vehicle display control device that controls a display device included in a vehicle, the in-vehicle display control device including: an obtainer that obtains candidate information that is a candidate for display on a display screen of the display device; and a display controller that causes visibility options to be displayed on the display screen, and causes the candidate information obtained by the obtainer to be displayed on the display screen when displaying the candidate information onto the display screen is selected in the visibility options, the visibility options being options of displaying or not displaying the candidate information onto the display screen.

According to the present disclosure, it is possible to realize an in-vehicle display control device and so forth capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing a vehicle in which an in-vehicle display system according to an embodiment is included.

FIG. 2 is a block diagram showing the functional configuration of the in-vehicle display system according to the embodiment.

FIG. 3 is a diagram showing a table that shows the relationship between applications and priorities.

FIG. 4 is a flowchart of the operation of the in-vehicle display system according to the embodiment.

FIG. 5 is a diagram showing a display screen on which visibility options are displayed, the display screen on which candidate information is displayed, and others.

FIG. 6 is a diagram showing the display screen on which candidate information is displayed in a part of a low-priority region, and others.

FIG. 7 is a diagram showing a list of items of candidate information.

FIG. 8 is a diagram showing the display screen on which two or more visibility options are displayed, and others.

FIG. 9 is a diagram showing the display screen on which the visibility options are displayed, the display screen on which candidate information overlaid on display information is displayed, the display screen on which emergency candidate information is displayed, and others.

FIG. 10 is a diagram showing the display screen on which the visibility options are displayed, the display screen on which candidate information overlaid on display information is displayed, the display screen on which emergency candidate information is displayed, and others.

FIG. 11 is a diagram showing the display screen on which the visibility options are displayed, the display screen on which candidate information overlaid on display information is displayed, the display screen on which emergency candidate information is displayed, with the candidate information overlaid on the display information also being displayed, and others.

FIG. 12 is a diagram showing how an update is performed to the priority of candidate information displayed on the display screen.

FIG. 13 is a diagram showing the case where the visibility options are displayed on a touchable display screen and candidate information is displayed on a non-touchable display screen.

FIG. 14 is a diagram showing the case where candidate information is displayed on a displayable screen.

### DESCRIPTION OF EMBODIMENT

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps, etc. shown in the following exemplary embodiment are mere examples, and therefore do not limit the scope of the present disclosure. Therefore, among the elements in the following exemplary embodiment, those not recited in any one of the independent claims are described as optional elements.

The drawings are schematic diagrams, and are not always strictly drawn. In the drawings, the same reference signs are assigned to substantially the same elements, and overlapping descriptions can be omitted or simplified.

### Embodiment

### Configuration

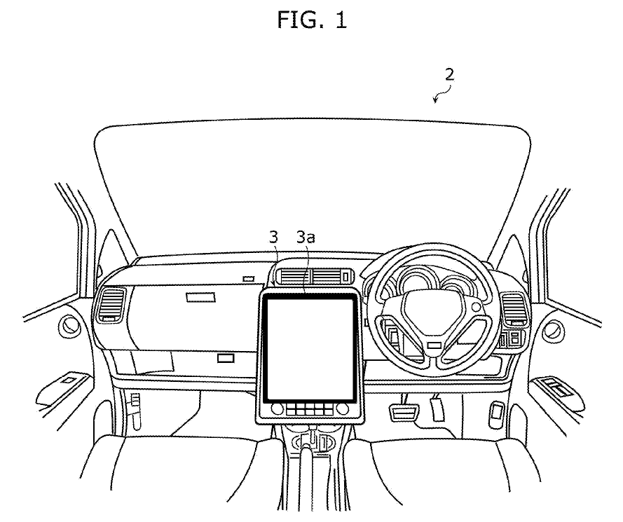

First, with reference to FIG. 1 to FIG. 3, the following describes in-vehicle display system 1 according to an embodiment.

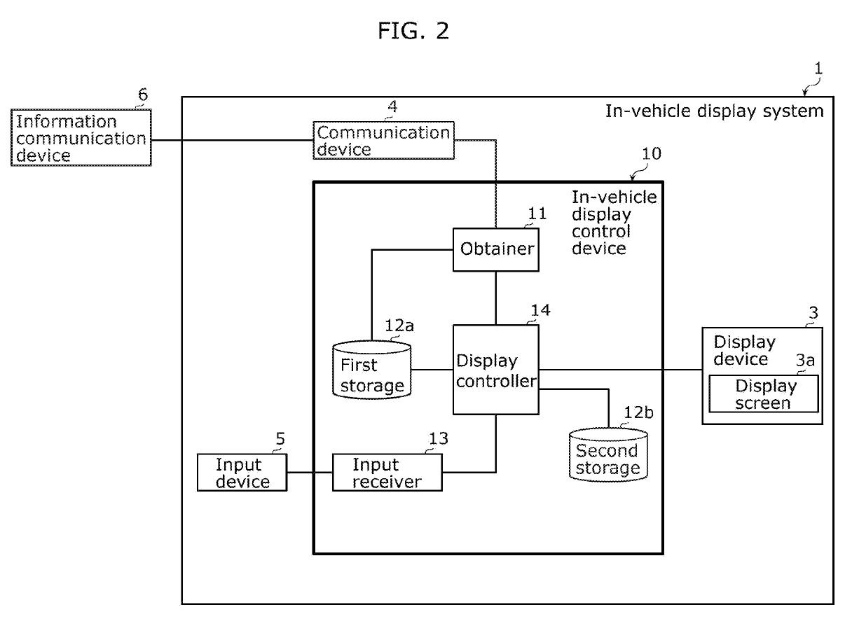

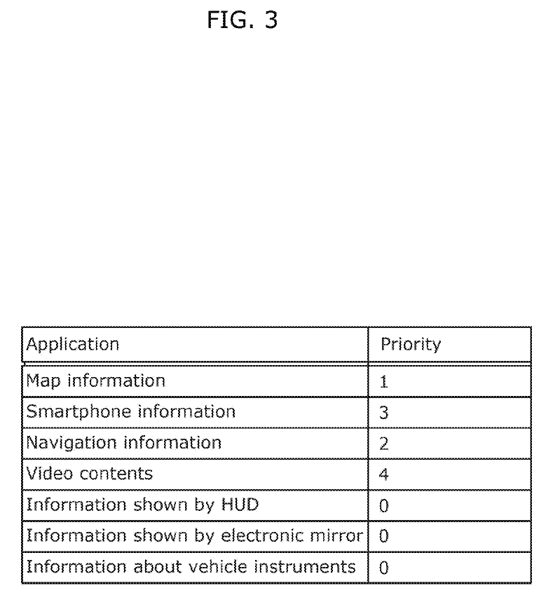

FIG. 1 is a diagram showing vehicle 2 in which in-vehicle display system 1 according to the embodiment is included. FIG. 2 is a block diagram showing the functional configuration of in-vehicle display system 1 according to the embodiment. FIG. 3 is a diagram showing a table that shows the relationship between applications and priorities.

As shown in FIG. 1, in-vehicle display system 1, which is included in vehicle 2, is a system for displaying a plurality of images on each screen 3a of one or more display devices 3. In-vehicle display system 1 is used, for example, in vehicle 2 in which one or more display devices 3 are included. In in-vehicle display system 1, it is possible to display, on display screen 3a of each of one or more display devices 3, display information automatically or manually by a user. In in-vehicle display system 1, it is also possible to divide display screen 3a into a plurality of regions and display mutually different items of information in the plurality of regions.

In the present embodiment, display information displayed on display screen 3a of one or more display devices 3 is an application-based image. Examples of the display information include map information, smartphone information, navigation information, content video, information shown by a head-up display (HUD), information shown by an electronic mirror, information about vehicle instruments, etc. The display information displayed on display screen 3 of the present embodiment is a mere example and may thus include other known information, without being limited to the example shown in the present embodiment. For example, the display information displayed on display screen 3a may include: information about a store located on the travel route of vehicle 2; information about the distance to the destination; a suggestion of an operation to be performed by a home appliance at the residence of the driver when such driver arrives within a predetermined distance from home (e.g., suggestion of whether to fill the bathtub with hot water); a suggestion of whether to check in at an accommodation when the driver arrives within a predetermined distance from the accommodation; the operational status of an in-vehicle device; captured images; information about nearby vehicles, etc.

The following describes the configuration of in-vehicle display system 1 in more detail.

In-vehicle display system 1 includes one or more display devices 3, communication device 4, input device 5, and in-vehicle display control device 10.

Each of one or more display devices 3 is a display device included in vehicle 2, such as a car navigation system, an electronic mirror system, a multi-information display, etc. and includes display screen 3a for displaying display information and others. When two or more display screens 3a are disposed in vehicle 2, such two or more display screens 3a may be aligned with each other in the vehicle interior for the user to collectively view these screens at once.

In display screen 3a of each of one or more display devices 3, it is possible to divide the display region into a plurality of regions and change, as appropriate, the size of regions into which the display region is divided, under the control performed by in-vehicle display control device 10.

Communication device 4 is a module used for communication between in-vehicle display system 1 and information communication device 6. Communication device 4 is communicably connected to information communication device 6, and is capable of receiving external information transmitted from information communication device 6 and outputting the received external information to in-vehicle display control device 10.

Information communication device 6 is an external device of in-vehicle display system 1, such as an external server located outside of vehicle 2, a mobile terminal of an occupant who is aboard vehicle 2, etc.

Input device 5 is an input interface for receiving user operations, such as a touch panel, a mechanical switch, etc. Upon receiving a user operation, input device 5 outputs the received operation as input information to in-vehicle display control device 10.

In-vehicle display control device 10 is a device for controlling one or more display devices 3 included in vehicle 2.

In-vehicle display control device 10 includes obtainer 11, first storage 12a, input receiver 13, second storage 12b, and display controller 14.

Obtainer 11 is an interface capable of obtaining, from communication device 4, the external information received by communication device 4. Obtainer 11 is configured to store the obtained external information onto first storage 12a by outputting the obtained external information to first storage 12a. Obtainer 11 is also configured to provide display controller 14 with a notification indicating that external information has been obtained, upon receiving the external information.

First storage 12a is a storage for storing the external information outputted from obtainer 11. First storage 12a is realized, for example, in the form of a semiconductor memory. Although the external information outputted from obtainer 11 is accumulated in first storage 12a, the external information may be deleted by the user operating input device 5 or may be automatically deleted in accordance with predetermined conditions that are set. First storage 12a is an example of the storage.

Input receiver 13 is an interface capable of obtaining input information inputted by input device 5 receiving a user operation. Input receiver 13 is configured to output the obtained input information to display controller 14.

Second storage 12b is a storage for storing a table that shows the correspondence between a plurality of items of display information (application-based images) to be displayed on display screen 3a and priorities that are set in advance to such plurality of items of display information. In the table, a priority is assigned to each of the plurality of items of display information. The contents of the table may be changed by the user operating input device 5. The priorities in the present embodiment indicate that the smaller the numerical value, the higher the priority.

Second storage 12b is realized, for example, in the form of a semiconductor memory.

Display controller 14 is configured to control images (images including the external information) to be displayed on display screen 3a of one or more display devices 3, upon receiving the notification from obtainer 11 indicating that the external information has been obtained, on the basis of the input information obtained from input receiver 13, the external information stored in first storage 12a, and the table stored in second storage 12b.

Display controller 14 is realized, for example, in the form of a microcomputer, but may also be realized in the form of a processor or a dedicated circuit. The functions of display controller 14 are realized by means of hardware, such as a microcomputer and a processor included in display controller 14, executing a computer program (software) stored in a recording medium.

### Functions and Operations

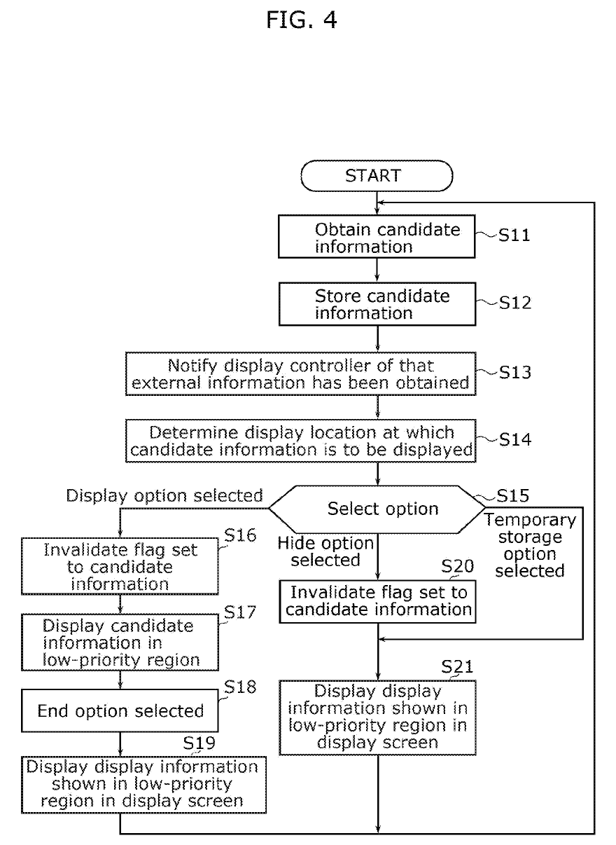

First, with reference to FIG. 4 to FIG. 7, the following describes the functions and the operations of in-vehicle display control device 10 according to the embodiment.

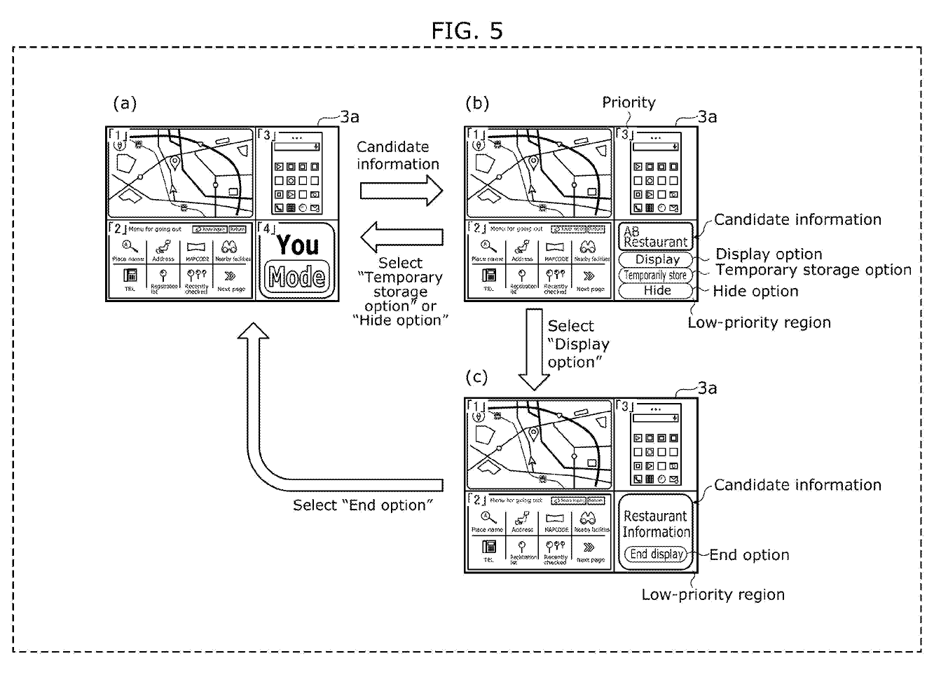

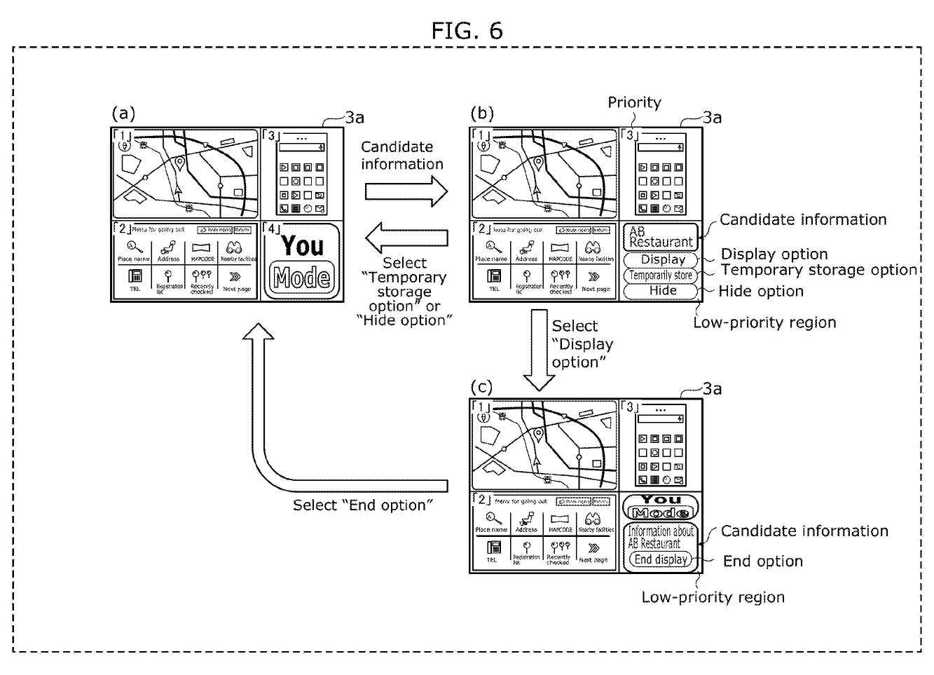

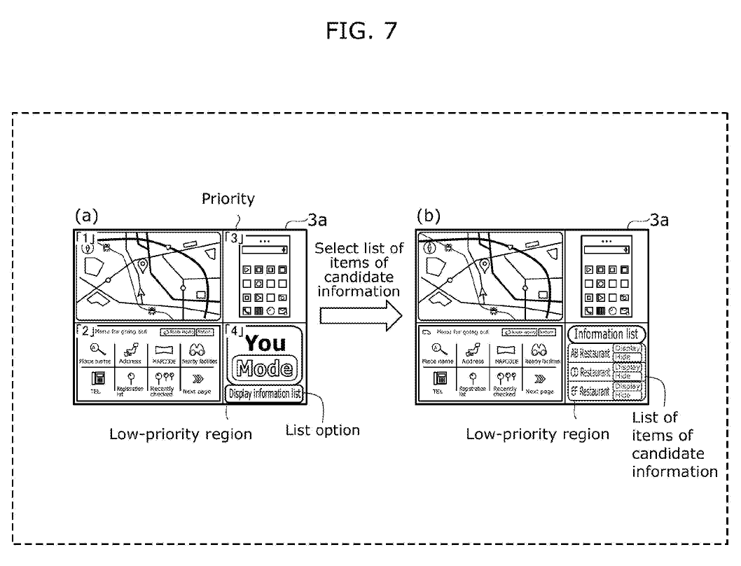

FIG. 4 is a flowchart of the operation of in-vehicle display system 1 according to the embodiment. FIG. 5 is a diagram showing display screen 3a on which visibility options are displayed, display screen 3a on which candidate information is displayed, and others. (a) in FIG. 5 shows display screen 3a on which a plurality of items of display information are displayed. (b) in FIG. 5 shows display screen 3a on which visibility options are displayed in a low-priority region. (c) in FIG. 5 shows display screen 3a on which candidate information is displayed in the entire low-priority region. FIG. 6 is a diagram showing display screen 3a on which candidate information is displayed in a part of the low-priority region, and others. (a) in FIG. 6 shows display screen 3a on which a plurality of items of display information are displayed. (b) in FIG. 6 shows display screen 3a on which the visibility options are displayed in the low-priority region. (c) in FIG. 6 shows display screen 3a on which candidate information is displayed in a part of the low-priority region. FIG. 7 is a diagram showing a list of items of candidate information. (a) in FIG. 7 shows a list option shown in the low-priority region of display screen 3a. (b) in FIG. 7 shows a list of items of candidate information. In FIG. 5 and the subsequent diagrams in the present embodiment, brackets shown in the upper left of each of the regions on display screen 3a are provided for describing the priorities, and are not shown on the actual display screen 3a. Each of the brackets indicates a priority and is represented by a natural number that is greater than or equal to 0.

The present operation example mainly assumes the case where single display screen 3a is divided into a plurality of regions, but the present operation example is applicable to the case were a plurality of display screens 3a are used.

Communication device 4 receives, from information communication device 6, external information transmitted from information communication device 6 and outputs the received external information to in-vehicle display control device 10. Here, the external information, which is information received from information communication device 6, is candidate information that is a candidate for display on display screen 3a of one or more display devices 3. For this reason, the external information is hereinafter referred to as “candidate information”.

As shown in FIG. 4 and (a) in FIG. 5, obtainer 11 of in-vehicle display control device 10 obtains candidate information outputted by communication device 4 (S11).

Since the candidate information is information that is a candidate for display on display screen 3a, obtainer 11 then sets a flag that takes into account the possibility that the obtained candidate information is to be temporarily stored will be selected in a temporary storage option. Obtainer 11 then outputs the flagged candidate information to first storage 12a, thereby storing such candidate information onto first storage 12a (S12).

Next, upon receiving the external information, obtainer 11 provides display controller 14 with a notification indicating that the external information has been obtained (S13).

Steps S12 and S13 may be simultaneously performed, and the order of S12 and S13 may be reversed.

Next, upon receiving, from obtainer 11, the notification indicating that the candidate information has been obtained, display controller 14 determines the location at which the candidate information stored in first storage 12a in step S12 will be displayed (such location is hereinafter referred to also as “display location”), using the table stored in second storage 12b (S14).

More specifically, display controller 14 extracts the display information with the lowest priority from among a plurality of items of display information displayed on display screen 3a, thereby determining, as the display location, the low-priority region of display screen 3a in which the extracted display information is currently displayed. The low-priority region is a region, on display screen 3a, in which the display information with the lowest priority is displayed.

Next, display controller 14 causes the following to be displayed in the low-priority region of display screen 3a instead of the display information with the lowest priority that is currently displayed in the low-priority display region of display screen 3a: the visibility options of displaying or not displaying the candidate information onto display screen 3a; and the temporary storage option indicating that the candidate information is to be temporarily stored. Display controller 14 causes the visibility options and the temporary storage option to be displayed aligned with each other in the low-priority region of display screen 3a. The visibility options of displaying or not displaying the candidate information onto display screen 3a include: a display option indicating that the candidate information is to be displayed on display screen 3a; and a hide option indicating that the candidate information is not to be displayed on display screen 3a.

As a result, the visibility options are presented to the user, thereby prompting the user to select one of the options (S15).

When the candidate information stored in first storage 12a in S11 is “AB Restaurant” located on the travel route of vehicle 2, for example, display controller 14 causes the following to be displayed in the low-priority region of display screen 3a as shown in (b) in FIG. 5: the display option for “Display” “AB Restaurant”; the hide option for “Hide” “AB Restaurant”; and the temporary storage option for “Temporarily store” “AB Restaurant”.

Here, when the display option for “Display” is selected and inputted to input device 5 by the user operating input device 5, input device 5 outputs “Display” as input information to in-vehicle display control device 10. As a result, input receiver 13 obtains such input information inputted by input device 5 receiving the user operation and outputs the input information to display controller 14 (in step S15, “Display option selected”).

When the display option is selected, display controller 14 invalidates (deletes) the flag set to the candidate information in step S12 (S16).

Next, display controller 14 causes the candidate information obtained in step S11 to be displayed in the low-priority region of display screen 3a (S17). As a result, in the divided regions into which display screen 3a is divided, the candidate information with priority “4” is displayed in the low-priority region of display screen 3a, and the items of display information with priorities “1” to “3” are displayed in the regions on display screen 3a other than the low-priority region, as shown in (c) in FIG. 5.

Although (c) in FIG. 5 illustrates the case where the candidate information is displayed in the entire low-priority region, the present embodiment is not limited to this. For example, display controller 14 may cause the candidate information to be displayed only in at least a part of the low-priority region, as shown in (c) in FIG. 6.

Next, display controller 14 causes an end option for “End display” to be displayed in a manner that such end option is overlaid on the candidate information displayed in the low-priority region.

Next, when the user wants to terminate the display of the candidate information that is currently displayed, the user selects the end option for “End display” by operating input device 5 (S18). Stated differently, the user selects the end option for “End display” and inputs it to input device 5. In this case, input device 5 outputs “End display” as input information to in-vehicle display control device 10. As a result, display controller 14 obtains such input information via input receiver 13 of in-vehicle display control device 10.

Since the end option indicating that the display of the candidate information is to be terminated has been selected, display controller 14 deletes the candidate information that has been displayed in the low-priority region of display screen 3a and causes the display information with priority “4” that was originally displayed in the low-priority region of display screen 3a to be displayed (S19). As a result, the items of display information with priorities “1” to “4” are displayed in the regions into which display screen 3a is divided, as shown in (a) in FIG. 5. Subsequently, in-vehicle display control device 10 returns to step S11.

Here, when the hide option for “Hide” is selected and inputted to input device 5 by the user operating input device 5, input device 5 outputs “Hide” as input information to in-vehicle display control device 10. As a result, input receiver 13 obtains such input information inputted by input device 5 receiving the user operation and outputs the input information to display controller 14 (in step S15, “Hide option selected”).

When the hide option is selected, display controller 14 invalidates (deletes) the flag set to the candidate information in step S12 (S20). When invalidating the flag, display controller 14 may also delete, from first storage 12a, the candidate information related to such invalidated flag.

Next, display controller 14 causes the display information with priority “4” that was originally displayed in the low-priority region of display screen 3a to be displayed, instead of all the options displayed in the low-priority region of display screen 3a (S21). As a result, the items of display information with priorities “1” to “4” are displayed in the regions into which display screen 3a is divided, as shown in (a) in FIG. 5.

Here, when the temporary storage option for “Temporarily store” is selected and inputted to input device 5 by the user operating input device 5, input device 5 outputs “Temporarily store” as input information to in-vehicle display control device 10. As a result, input receiver 13 obtains such input information inputted by input device 5 receiving the user operation and outputs the input information to display controller 14 (in step S15, “Temporary storage option selected”).

In this case, display controller 14 causes the flagged candidate information to be continuously stored in first storage 12a together with the flag via input receiver 13 in step S12. When receiving a deletion instruction from the user, display controller 14 may delete the temporarily stored flag from first storage 12a and may delete the temporarily stored candidate information from first storage 12a.

Note that in-vehicle display control device 10 of the present embodiment may also have a function of displaying a list option as shown in FIG. 7. For example, display controller 14 may further cause the list option of displaying a list of the items of temporarily stored candidate information to be displayed in the low-priority region of display screen 3a, as shown in (a) in FIG. 7. When the list option is selected and inputted to input device 5 by the user operating input device 5, input device 5 may output “Display information list” as input information to in-vehicle display control device 10. As a result, input receiver 13 obtains such input information inputted by input device 5 receiving the user operation. Upon obtaining the input information via input receiver 13, display controller 14 may cause the list of the items of temporarily stored candidate information stored in first storage 12a to be displayed in the low-priority region of display screen 3a, as shown in (b) in FIG. 7. The list shows the visibility options for each candidate information, but may further show the temporary storage option.

Since the temporary storage option of temporarily storing the candidate information has been selected, display controller 14 then deletes all the options that have been displayed in the low-priority region of display screen 3a and causes the display information with priority “4” that was originally displayed in the low-priority region of display screen 3a to be displayed (S21). As a result, the items of display information with priorities “1” to “4” are displayed in the regions into which display screen 3a is divided, as shown in (a) in FIG. 5.

As described above, by receiving the notification from obtainer 11 indicating that the candidate information has been obtained, it is possible for display controller 14 to control images (images including the candidate information) to be displayed on display screen 3a of one or more display devices 3, on the basis of the input information obtained from input receiver 13, the candidate information stored in first storage 12a, and the table stored in second storage 12b.

Note that when a plurality of items of display information with the lowest priority are present, display controller 14 may determine the display location at which candidate information is to be displayed, in accordance with setting rules defined in advance. The setting rules are, for example, rules such as a predetermined location of display screen 3a set in advance, the total hours of display by the applications, the number of times the user has looked at each display information, etc.

The priorities are set in advance in a tabular form, but may be dynamically changed by display controller 14 in accordance with the predetermined location of display screen 3a set in advance, the total hours of information display by the applications, the number of times the user has looked at each display information, etc.

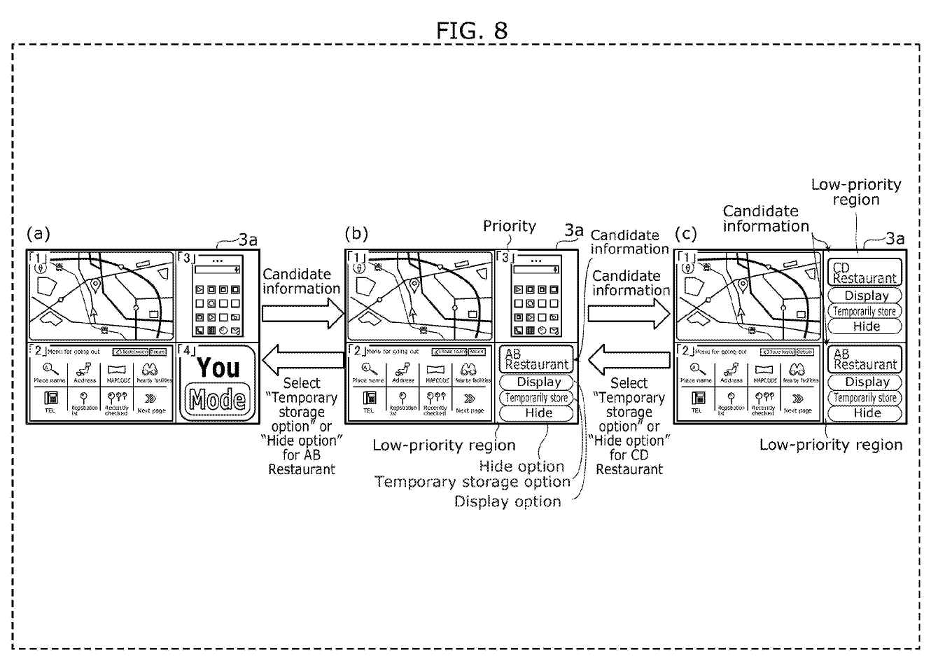

Further, in-vehicle display control device 10 of the present embodiment may also have a function described below of displaying the visibility options in a plurality of locations in the divided regions into which display screen 3a is divided. With reference to FIG. 8, the following describes the function and the operation of in-vehicle display control device 10 according to the present embodiment.

FIG. 8 is a diagram showing display screen 3a on which two or more visibility options are displayed, and others. (a) in FIG. 8 shows display screen 3a on which a plurality of items of display information are displayed. (b) in FIG. 8 shows display screen 3a on which the visibility options are displayed in the low-priority region. (c) in FIG. 8 shows display screen 3a on which the visibility options are displayed on each of the two items of display information in descending order of priority.

The above description shows the case where obtainer 11 obtains one candidate information (referred to, for example, as “first candidate information”). When obtainer 11 additionally obtains candidate information (referred to, for example, as “second candidate information”), it is possible to display the second candidate information additionally obtained onto display screen 3a.

When obtainer 11 obtains the first candidate information, display controller 14 causes the visibility options to be displayed in the low-priority region of display screen 3a. When obtainer 11 additionally obtains the second candidate information, display controller 14 causes the visibility options to be displayed in another region to serve as the low-priority region of display screen 3a. In so doing, display controller 14 further extracts the display information with the lowest priority from among a plurality of items of display information displayed on display screen 3a, excluding the low-priority region in which the visibility options are already displayed, and causes the visibility options to be displayed in the low-priority region of display screen 3a in which the extracted display information with the lowest priority is currently displayed, instead of the extracted display information with the lowest priority.

When obtainer 11 obtains the first candidate information, for example, display controller 14 causes the visibility options related to the first candidate information to be displayed in the low-priority region in which the display information with the lowest priority “4” is displayed among the items of display information with priorities “1” to “4”, as shown in (a) and (b) in FIG. 8. Further, when obtainer 11 additionally obtains the second candidate information, display controller 14 causes the visibility options related to the second candidate information to be displayed in the low-priority region in which the display information with the lowest priority “3” is displayed among the items of display information with priorities “1” to “3”, as shown in (b) and (c) in FIG. 8. Note that in (b) and (c) in FIG. 8, the temporary storage option is further displayed in the low-priority regions of display screen 3a.

As described above, when obtainer 11 obtains two or more items of candidate information, display controller 14 extracts two or more items of display information in descending order of priority from among the plurality of items of display information, and determines, as the display locations, the low-priority regions in which such extracted two or more items of display information are displayed. Note that even when two or more items of candidate information are obtained, display controller 14 may partially extract only at least one candidate information out of such two or more items of candidate information, and cause the visibility options related to such extracted at least one candidate information to be displayed in the low-priority region. As the at least one candidate information out of the two or more items of candidate information, only candidate information with a priority that is higher than or equal to a predetermined priority set in advance may be extracted. Alternatively, only candidate information with a priority that is higher than or equal to the predetermined priority may be extracted by the user inputting such predetermined priority to input device 5. In this case, the remaining items of candidate information may be stored onto first storage 12a or may be discarded.

Note that (c) in FIG. 8 illustrates the case where the visibility options are displayed in the low-priority regions of display screen 3a, but there can be cases where the display option indicating that the candidate information is to be displayed on display screen 3a has already been selected and the first candidate information is displayed in the low-priority region of display screen 3a. Also in this case, when obtainer 11 additionally obtains the second candidate information, display controller 14 may further extract the display information with the lowest priority from among the plurality of items of display information displayed on display screen 3a, excluding the low-priority region in which the first candidate information is displayed, and cause the visibility options to be displayed in the low-priority region of display screen 3a instead of the extracted display information with the lowest priority. Alternatively, when obtainer 11 additionally obtains the second candidate information, display controller 14 may cause the visibility options of displaying or not displaying the second candidate information to be displayed in the low-priority region of display screen 3a in which the first candidate information is currently displayed, instead of the first candidate information.

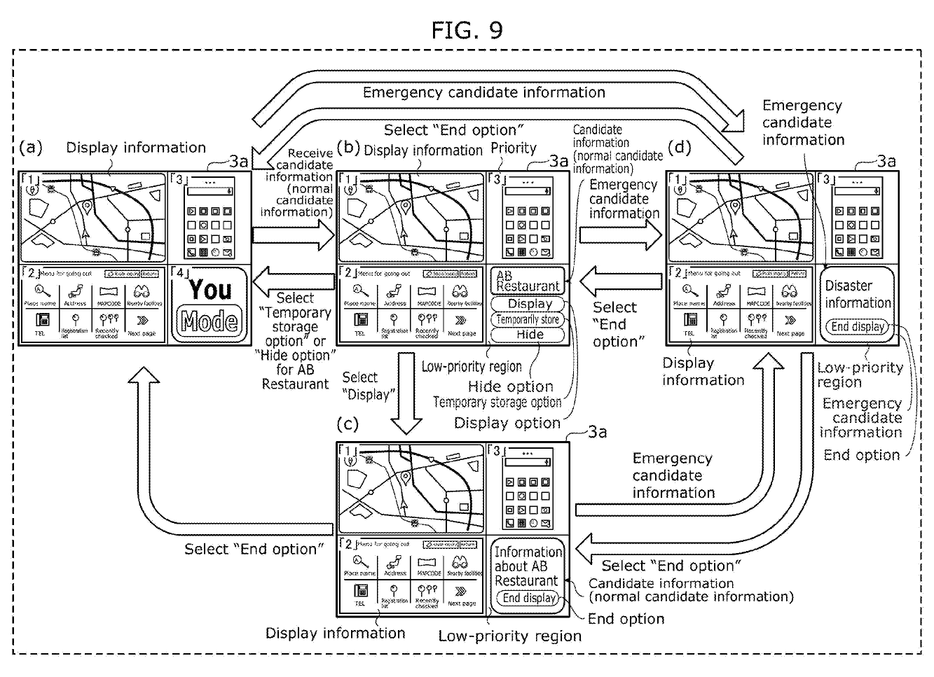

Further, in-vehicle display control device 10 of the present embodiment may also have a function described below of displaying emergency candidate information. With reference to FIG. 9, the following describes the function and the operation of in-vehicle display control device 10 according to the embodiment.

FIG. 9 is a diagram showing display screen 3a on which the visibility options are displayed, display screen 3a on which candidate information overlaid on display information is displayed, and display screen 3a on which emergency candidate information is displayed, and others. (a) in FIG. 9 shows display screen 3a on which a plurality of items of display information are displayed. (b) in FIG. 9 shows display screen 3a on which the visibility options are displayed in the low-priority region. (c) in FIG. 9 shows display screen 3a on which candidate information is displayed in the low-priority region. (d) in FIG. 9 shows display screen 3a on which emergency candidate information is displayed in the low-priority region.

The candidate information may include emergency candidate information indicating emergency and normal candidate information other than emergency candidate information. Emergency candidate information is, for example, information related to disasters, information related anomalies in vehicle 2, etc. Normal candidate information is, for example, map information, smartphone information, navigation information, contents video, etc.

In this case, when obtainer 11 obtains emergency candidate information, it is possible for display controller 14 to cause the emergency candidate information to be displayed in the low-priority region of display screen 3a instead of one of: the display information with the lowest priority; the visibility options of displaying or not displaying normal candidate information in the low-priority region of display screen 3a; and the normal candidate information displayed in the low-priority region of display screen 3a.

For example, there can be the case where obtainer 11 obtains emergency candidate information when a plurality of items of display information are currently displayed on display screen 3a by display controller 14, as shown in (a) in FIG. 9. In this case, display controller 14 causes the emergency candidate information to be displayed in the low-priority region of display screen 3a instead of the display information currently displayed in the low-priority region of display screen 3a, as shown in (d) in FIG. 9.

Also, there can be the case where obtainer 11 obtains emergency candidate information when the visibility options of displaying or not displaying normal candidate information in the low-priority region of display screen 3a are currently displayed by display controller 14 in response to the obtainment of the normal candidate information by obtainer 11, as shown in (b) in FIG. 9. In this case, display controller 14 causes the emergency candidate information to be displayed in the low-priority region of display screen 3a instead of the visibility options of displaying or not displaying the normal candidate information in the low-priority region of display screen 3a, as shown in (d) in FIG. 9. Note that in (b) in FIG. 9, the temporary storage option is further displayed in such low-priority region of display screen 3a.

In addition, display controller 14 causes the end option for “End display” to be displayed in a manner that such end option is overlaid on the emergency candidate information displayed in the low-priority region shown in (d) in FIG. 9. When the end option for “End display” is selected and inputted to input device 5 by the user operating input device 5, input device 5 outputs “End display” as input information to in-vehicle display control device 10. When the end option is selected which indicates that the display of the emergency candidate information is to be terminated, display controller 14 of in-vehicle display control device 10 terminates the display of the emergency candidate information that has been displayed in the low-priority region of display screen 3a and causes the visibility options of displaying or not displaying the normal candidate information that were originally displayed in the low-priority region of display screen 3 to be displayed in the low-priority region of display screen 3a, as shown in (b) in FIG. 9.

In addition, there can be the case where obtainer 11 obtains normal candidate information and the display option is selected which indicates that the normal candidate information is to be displayed on display screen 3a, in response to which the normal candidate information is displayed in the low-priority region of display screen 3a by display controller 14, as shown in (c) in FIG. 9. In this case, when obtainer 11 obtains emergency candidate information, it is possible for display controller 14 to cause the emergency candidate information to be displayed in the low-priority region of display screen 3a instead of the normal candidate information that is currently displayed in the low-priority region of display screen 3a, as shown in (c) and (d) in FIG. 9.

In addition, display controller 14 causes the end option for “End display” to be displayed in a manner that such end option is overlaid on the emergency candidate information displayed in the low-priority region shown in (d) in FIG. 9. When the end option for “End display” is selected and inputted to input device 5 by the user operating input device 5, input device 5 outputs “End display” as input information to in-vehicle display control device 10. When the end option is selected which indicates that the display of the emergency candidate information is to be terminated, display controller 14 of in-vehicle display control device 10 terminates the display of the emergency candidate information that has been displayed in the low-priority region of display screen 3a and causes the normal candidate information that was originally displayed in the low-priority region of display screen 3a to be displayed, as shown in (c) in FIG. 9. Note that in (c) in FIG. 9, the end option is further shown on the normal candidate information. When such end option is selected, display controller 14 causes the plurality of items of display information that were displayed on display screen 3a to be displayed, as shown in (a) in FIG. 9.

Note that even when obtainer 11 obtains emergency candidate information, display controller 14 may cause an option of displaying or not displaying the emergency candidate information to be displayed onto display screen 3a.

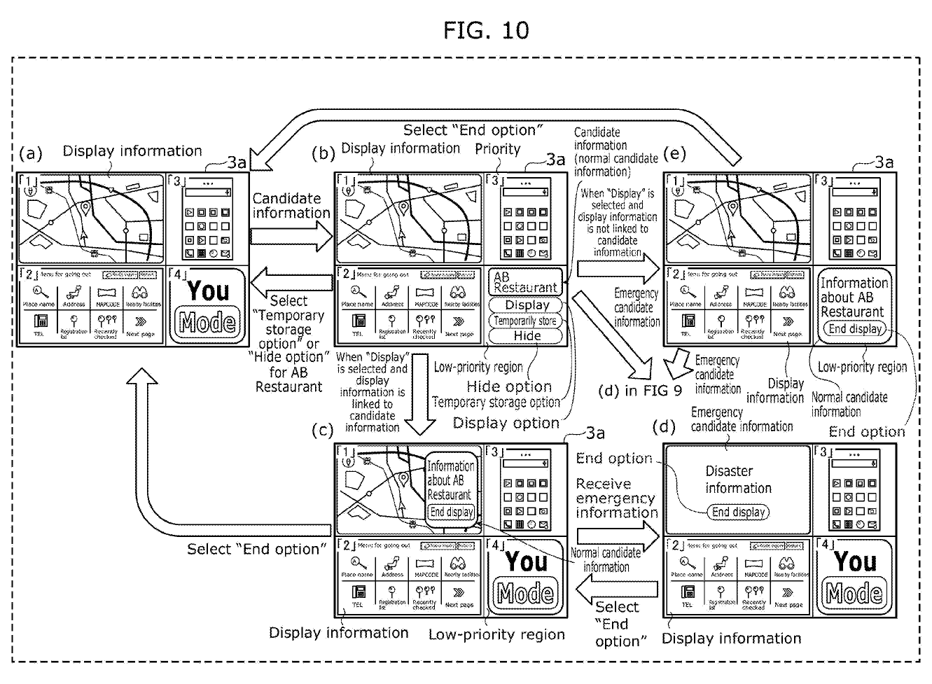

Further, in-vehicle display control device 10 of the present embodiment may also have a function described below of displaying candidate information (normal candidate information) overlaid on display information and a function described below of displaying emergency candidate information. With reference to FIG. 10, the following describes the functions and the operations of in-vehicle display control device 10 according to the present embodiment.

FIG. 10 is a diagram showing display screen 3a on which the visibility options are displayed, display screen 3a on which candidate information overlaid on display information is displayed, and display screen 3a on which emergency candidate information is displayed, and others. (a) in FIG. 10 shows display screen 3a on which a plurality of items of display information are displayed. (b) in FIG. 10 shows display screen 3a on which the visibility options are displayed in the low-priority region. (c) in FIG. 10 shows display screen 3a on which candidate information overlaid on display information is displayed. (d) in FIG. 10 shows display screen 3a on which emergency candidate information is displayed. (e) in FIG. 10 shows display screen 3a on which the candidate information is displayed in the low-priority region.

Depending on the type, candidate information is associated with (linked to) one of a plurality of items of display information. For this reason, when a plurality of items of display information are displayed on display screen 3a, and candidate information obtained by obtainer 11 is linked to one of such plurality of items of display information, display controller 14 causes the candidate information to be displayed on display screen 3a in a manner that such candidate information is overlaid on the one display information to which such candidate information is linked.

For example, there can be the case where candidate information obtained is linked to one display information among a plurality of items of display information displayed on display screen 3a. Stated differently, there can be the case where the application for displaying the obtained candidate information coincides with one of the applications for displaying the plurality of items of display information currently displayed on display screen 3a.

When the candidate information obtained by obtainer 11 is information about a restaurant called “AB Restaurant” and the location of “AB Restaurant” is shown in the map information, as shown in (a) and (b) in FIG. 10, it can be considered that such candidate information is related to the display information with priority “1” showing the map information. For this reason, it can be said that the candidate information is linked to the display information with priority “1”. When the candidate information obtained by obtainer 11 is linked to the display information with priority “1”, that is, when the application for displaying the candidate information coincides with the application for displaying the display information with priority “1”, display controller 14 causes the candidate information to be displayed on display screen 3a in a manner that such candidate information is overlaid on at least a part of the display information with priority “1”, as shown in (c) in FIG. 10, when the display option is selected which indicates that the candidate information is to be displayed on display screen 3a. Display controller 14 then terminates the display of the visibility options that have been displayed in the low-priority region of display screen 3a and causes the display information that was originally displayed in the low-priority region of display screen 3a to be displayed in the low-priority region. Note that in (b) in FIG. 10, the temporary storage option is further displayed in the low-priority region of display screen 3a. In (c) in FIG. 10, the end option is further shown on the normal candidate information. When such end option is selected, display controller 14 causes the plurality of items of display information that were displayed on display screen 3a to be displayed, as shown in (a) in FIG. 10.

At this time, when obtainer 11 obtains emergency candidate information, display controller 14 causes the emergency candidate information to be displayed on display screen 3a (in the priority region in which the display information with priority “1” is displayed) instead of the display information with priority “1” and the candidate information (normal candidate information) overlaid on at least a part of such display information, as shown in (c) and (d) in FIG. 10. Stated differently, when obtainer 11 obtains the emergency candidate information after obtaining the normal candidate information, display controller 14 causes the emergency candidate information to be displayed on display screen 3a instead of the one display information to which such candidate information is linked.

In addition, similar to the case described above, display controller 14 is capable of causing the end option for “End display” to be displayed in a manner that such end option is overlaid on such emergency candidate information. When the end option is selected which indicates that the display of the emergency candidate information is to be terminated, display controller 14 terminates the display of the emergency candidate information that is currently displayed in the priority region of display screen 3a and causes the following to be displayed on display screen 3a: the display information with priority “1” that was originally displayed in the priority region of display screen 3a; and the normal candidate information overlaid on such display information.

In addition, when the candidate information obtained by obtainer 11 is information about a restaurant called “AB Restaurant” and the location of “AB Restaurant” is not shown in the map information, as shown in (b) and (e) in FIG. 10, it is considered that such candidate information is not associated with (not linked to) the display information with priority “1” showing the map information. For this reason, it can be said that the candidate information is linked to none of the items of display information displayed on display screen 3a. Stated differently, the application for displaying the candidate information coincides with none of the applications for displaying the items of display information on display screen 3a. In this case, when obtainer 11 obtains candidate information and the display option is selected which indicates that the candidate information is to be displayed on display screen 3a, it is possible for display controller 14 to start the application for displaying the candidate information and cause the candidate information to be displayed in the low-priority region of display screen 3a, instead of the display information with priority “4”, as shown in (e) in FIG. 10.

Note that in (e) in FIG. 10, the end option is further shown on the normal candidate information. When such end option is selected, display controller 14 causes the plurality of items of display information that were displayed on display screen 3a to be displayed, as shown in (a) in FIG. 10.

In both of the cases shown in (b) and (e) in FIG. 10, when emergency candidate information is obtained, display controller 14 causes the emergency candidate information to be displayed in the low-priority region of display screen 3a, as shown in (d) in FIG. 9.

As described above, as is shown in FIG. 10, it is possible to change the display location depending on the type of candidate information obtained.

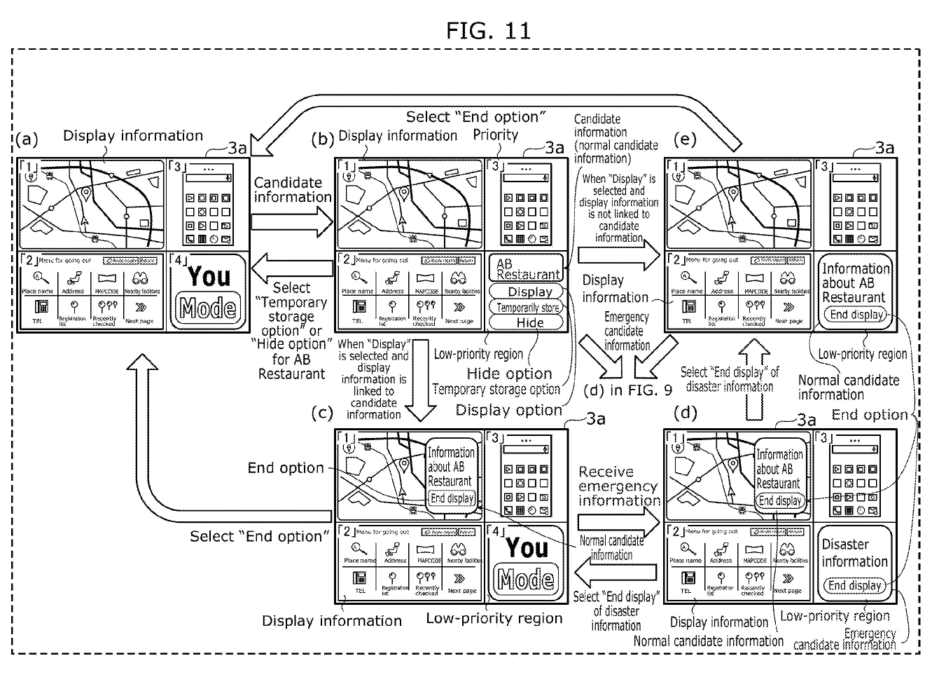

Further, in-vehicle display control device 10 of the present embodiment may also have a function described below of displaying candidate information (normal candidate information) overlaid on display information and a function described below of displaying emergency candidate information. With reference to FIG. 11, the following describes the functions and the operations of in-vehicle display control device 10 according to the present embodiment. FIG. 11 shows another example case where the location at which the emergency candidate information is displayed differs from that shown in FIG. 10. The description of the same details as those of FIG. 10 is omitted as appropriate.

FIG. 11 is a diagram showing display screen 3a on which the visibility options are displayed, display screen 3a on which candidate information overlaid on display information is displayed, and display screen 3a on which emergency candidate information is displayed, with the candidate information overlaid on the display information also being displayed, and others. (a) in FIG. 11 shows display screen 3a on which a plurality of items of display information are displayed. (b) in FIG. 11 shows display screen 3a on which the visibility options are displayed in the low-priority region. (c) in FIG. 11 shows display screen 3a on which candidate information overlaid on display information is displayed. (d) in FIG. 11 shows display screen 3a on which the candidate information overlaid on the display information with priority “1” is displayed and on which emergency candidate information is displayed in the low-priority region. (e) in FIG. 11 shows display screen 3a on which the candidate information is displayed in the low-priority region.

When a plurality of items of display information are displayed on display screen 3a and normal candidate information obtained by obtainer 11 is linked to one of such plurality of items of display information, display controller 14 causes the normal candidate information to be displayed on display screen 3a in a manner that such normal candidate information is overlaid on the one display information to which such normal candidate information is linked. In addition, when obtainer 11 obtains emergency candidate information after obtaining the normal candidate information, display controller 14 further extracts the display information with the lowest priority from among the plurality of items of display information, and causes the emergency candidate information to be displayed in the low-priority region of display screen 3a in which the extracted display information is currently displayed, instead of the display information with the lowest priority.

For example, when obtainer 11 obtains normal candidate information and the normal candidate information obtained by obtainer 11 is linked to the display information with priority “1”, display controller 14 causes the normal candidate information to be displayed on display screen 3a in a manner that such normal candidate information is overlaid on at least a part of the display information with priority “1”, as shown in (a) to (c) in FIG. 11, when the display option is selected which indicates that the normal candidate information is to be displayed on display screen 3a. Display controller 14 then terminates the display of the visibility options that have been displayed in the low-priority region of display screen 3a and causes the display information that was originally displayed in the low-priority region of display screen 3a to be displayed. Note that in (b) in FIG. 11, the temporary storage option is further displayed in such low-priority region of display screen 3a. Note that in (c) in FIG. 11, the end option is further shown on the normal candidate information. When such end option is selected, display controller 14 causes the plurality of items of display information that were displayed on display screen 3a to be displayed, as shown in (a) in FIG. 11.

At this time, when obtainer 11 obtains emergency candidate information, display controller 14 causes the emergency candidate information to be displayed in the low-priority region of display screen 3a instead of the display information with priority “4” currently displayed in the low-priority region of display screen 3a, while maintaining the state in which the normal candidate information is displayed on display screen 3a in a manner that such normal candidate information is overlaid on at least a part of the display information with priority “1”, as shown in (c) and (d) in FIG. 11.

Further, when the normal candidate information obtained by obtainer 11 is linked to none of the plurality of items of display information, it is possible for display controller 14 to cause the normal candidate information to be displayed in the low-priority region of display screen 3a, as shown in (b) and (e) in FIG. 11, when the display option is selected which indicates that the normal candidate information is to be displayed on display screen 3a. Note that in (e) in FIG. 11, the end option is further shown on the normal candidate information. When such end option is selected, display controller 14 causes the plurality of items of display information that were displayed on display screen 3a to be displayed, as shown in (a) in FIG. 11.

In addition, even in the cases shown in (b) and (e) in FIG. 11, when emergency candidate information is obtained, display controller 14 causes the emergency candidate information to be displayed in the low-priority region of display screen 3a, as shown in (d) in FIG. 9.

As described above, also in the case shown in FIG. 11, it is possible to change the display location depending on the type of candidate information obtained.

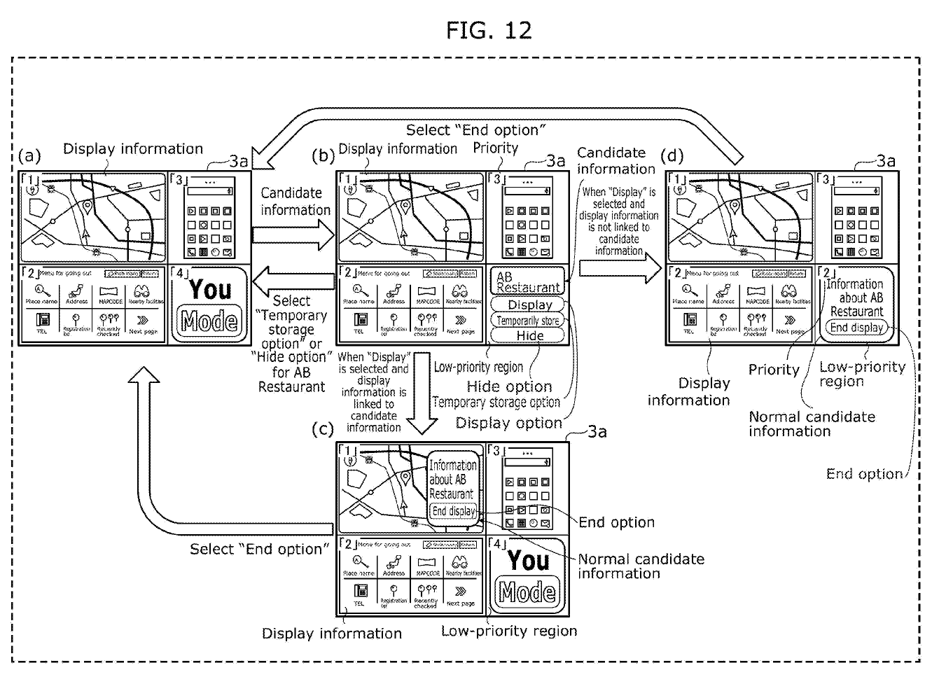

Further, in-vehicle display control device 10 of the present embodiment may also have a function described below of displaying candidate information to which a priority is assigned. With reference to FIG. 12, the following describes the function and the operation of in-vehicle display control device 10 according to the present embodiment.

FIG. 12 is a diagram showing how an update is performed to the priority of candidate information displayed on the display screen. (a) in FIG. 12 shows display screen 3a on which a plurality of items of display information are displayed. (b) in FIG. 12 shows display screen 3a on which the visibility options are displayed in the low-priority region. (c) in FIG. 12 shows display screen 3a on which candidate information overlaid on display information is displayed. (d) in FIG. 12 shows display screen 3a on which the candidate information is displayed in the low-priority region.

When obtainer 11 obtains candidate information, after which displaying the candidate information onto display screen 3a is selected in the visibility options, display controller 14 performs an update to the priority assigned to the candidate information and causes the candidate information to be displayed on display screen 3a. More specifically, the priority assigned to the candidate information refers to the priority assigned to the application that is linked to such candidate information.

For example, when obtainer 11 obtains candidate information, display controller 14 causes the visibility options to be displayed in the low-priority region of display screen 3a instead of the display information with the lowest priority, as shown in (a) and (b) in FIG. 12. Note that in (b) in FIG. 12, the temporary storage option is further displayed in such low-priority region of display screen 3a.

When the candidate information obtained by obtainer 11 is linked to none of the plurality of items of display information, it is possible for display controller 14 to cause the candidate information to be displayed in the low-priority region of display screen 3a, as shown in (d) in FIG. 12, when the display option is selected which indicates that the candidate information is to be displayed on display screen 3a. At this time, when the priority of the candidate information obtained by obtainer 11 is set to “2” in the table in second storage 12b, that is, when the priority of the application for displaying the candidate information is set to “2”, display controller 14 causes the candidate information to be displayed on display screen 3a as the candidate information with priority “2”. In this case, the region in which the candidate information with priority “2” is displayed is no longer the low-priority region, and the region in which the display information with priority “3” is displayed serves as the low-priority region. For this reason, when obtainer 11 obtains new candidate information, display controller 14 causes the visibility options to be displayed in the low-priority region in which the display information with priority “3” is displayed.

For example, when the candidate information obtained by obtainer 11 is linked to the display information with priority “1”, display controller 14 causes the normal candidate information to be displayed on display screen 3a in a manner that such normal candidate information is overlaid on at least a part of the display information with priority “1”, as shown in (c) in FIG. 12, when the display option indicating that the candidate information is to be displayed on display screen 3a is selected. Display controller 14 then terminates the display of the visibility options that have been displayed in the low-priority region of display screen 3a and causes the display information that was originally displayed in the low-priority region of display screen 3a to be displayed.

Note that in (c) and (d) in FIG. 12, the end option is further shown on the normal candidate information. When such end option is selected, display controller 14 causes the plurality of items of display information that were displayed on display screen 3a to be displayed, as shown in (a) in FIG. 12.

In the case shown in FIG. 12, too, the same operation is performed also in the case where candidate information includes emergency candidate information and normal candidate information, as in the case shown in FIG. 9 to FIG. 11 described above.

As described above, also in the case shown in FIG. 12, it is possible to change the display location depending on the type of candidate information obtained.

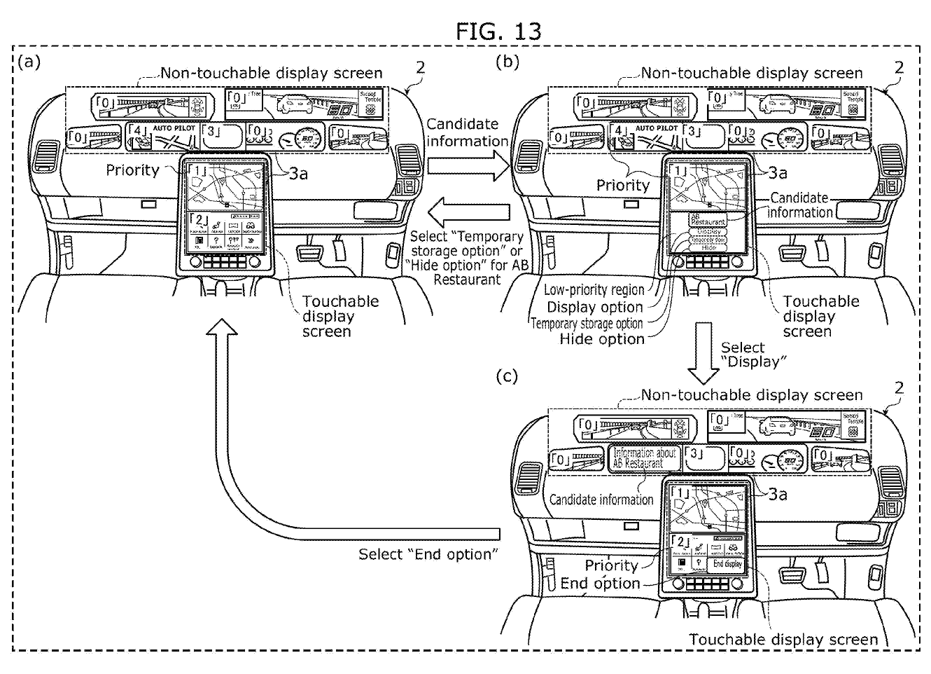

Further, in-vehicle display control device 10 of the present embodiment may also have a function described below of displaying candidate information on each of one or more display screens 3a of a plurality of display devices 3. With reference to FIG. 13, the following describes the function and the operation of in-vehicle display control device 10 according to the present embodiment.

FIG. 13 is a diagram showing the case where the visibility options are displayed on a touchable display screen and candidate information is displayed on a non-touchable display screen. (a) in FIG. 13 shows one or more touchable display screens and one or more non-touchable display screens. (b) in FIG. 13 shows the case where the visibility options are displayed on a touchable display screen. (c) in FIG. 13 shows the case where candidate information is displayed on a non-touchable display screen.

For example, as shown in (a) in FIG. 13, a plurality of display screens 3a include one or more touchable display screens having an input function and one or more non-touchable display screens having no input function. As such, the one or more touchable display screens are set to display the visibility options and the one or more non-touchable display screens are set not to display the visibility options. Note that when a non-touchable display screen is capable of receiving an input by means of voice input, for example, the visibility options may be displayed on the non-touchable display screen. Stated differently, in-vehicle display control device 10 is simply required to be set to display the visibility options onto display screen 3a that is capable of receiving inputs from the user.

(b) in FIG. 13 illustrates an example where the one or more touchable display screens are a touchable display screen on which the display information with priority “1” is displayed and a touchable display screen on which the display information with priority “2” is displayed. (b) in FIG. 13 also illustrates an example where the one or more non-touchable display screens are a non-touchable display screen on which the display information with priority “3” is displayed, a non-touchable display screen on which the display information with priority “4” is displayed, and non-touchable display screens on which one or more items of display information with priority “0” (no priority assigned) are displayed.

Here, priority “0” (no priority assigned) does not mean that the priority is low, but means that no priority is assigned to display information and the display information with priority “0” is not subjected to extraction when display controller 14 extracts display information with the lowest priority from among a plurality of items of display information.

Display controller 14 extracts the display information with the lowest priority from among one or more items of display information displayed on the one or more touchable display screens, and causes the visibility options to be displayed on the touchable display screen on which the extracted display information with the lowest priority is currently displayed, instead of the extracted display information with the lowest priority.

For example, the display information with priority “4” has the lowest priority, but is displayed on a non-touchable display screen. For this reason, when obtainer 11 obtains candidate information, display controller 14 extracts the display information with the lowest priority “2” from among the one or more items of display information displayed on the one or more touchable display screens, and causes the visibility options to be displayed on the touchable display screen (low-priority region), instead of the extracted display information with the lowest priority “2”. In (b) in FIG. 13, the temporary storage option is displayed on the touchable display screen in addition to the visibility options by display controller 14.

When displaying the candidate information onto display screen 3a is selected in the visibility options, display controller 14 causes the candidate information to be displayed on the non-touchable display screen on which the display information with priority “4” is currently displayed, instead of the display information with the lowest priority “4”, as shown in (c) in FIG. 13.

In addition, display controller 14 causes the end option indicating that the display is to be terminated to be displayed on the one or more touchable display screens instead of the one or more non-touchable display screens. For example, display controller 14 causes the end option for “End display” to be displayed in a manner that such end option is overlaid on the display information with the lowest priority from among the one or more items of display information displayed on the one or more touchable display screens.

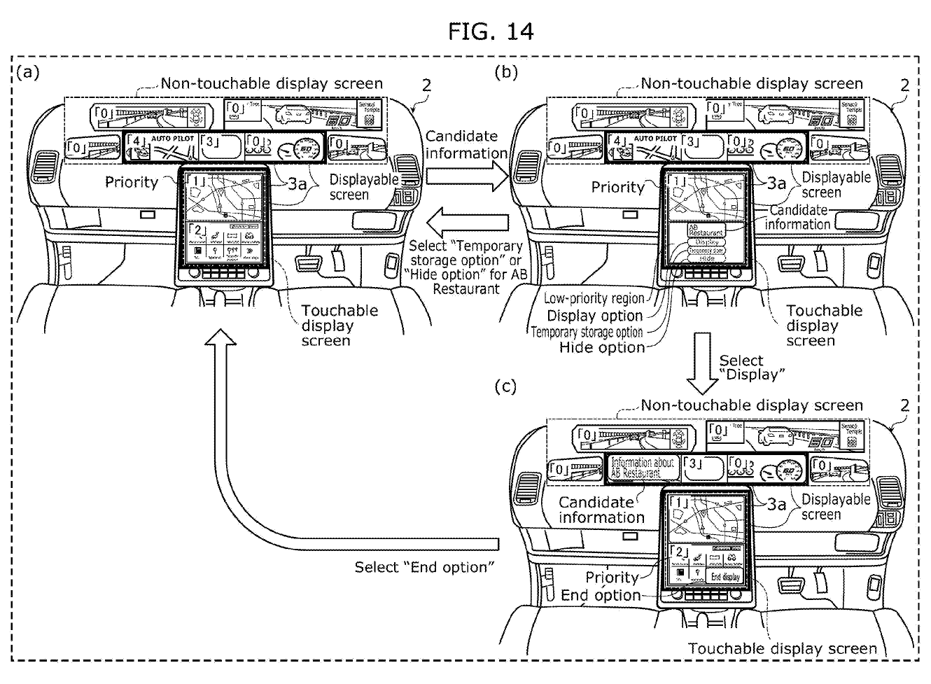

Further, in-vehicle display control device 10 of the present embodiment may also have the function described below. With reference to FIG. 14, the following describes the function and the operation of in-vehicle display control device 10 according to the present embodiment.

FIG. 14 is a diagram showing the case where candidate information is displayed on a displayable screen. (a) in FIG. 14 shows one or more displayable screens, one or more touchable display screens, and one or more non-touchable display screens. (b) in FIG. 14 shows the case where the visibility options are displayed on a displayable screen in a touchable display screen. (c) in FIG. 14 shows the case where candidate information is displayed on a displayable screen in a non-touchable display screen.

For example, as shown in (a) in FIG. 14, a plurality of display screens 3a include one or more touchable display screens having an input function and one or more non-touchable display screens having no input function. Further, one or more displayable screens capable of displaying candidate information are set out of the one or more touchable display screens and the one or more non-touchable display screens. The one or more displayable screens may be set by the user operating input device 5, or may be set in advance.

(b) in FIG. 14 illustrates an example where the touchable display screen on which the display information with priority “1” is displayed and the touchable display screen on which the display information with priority “2” is displayed are shown as the one or more touchable display screens and displayable screens. (b) in FIG. 14 also illustrates an example where the non-touchable display screen on which the display information with priority “3” is displayed, the non-touchable display screen on which the display information with priority “4” is displayed, and the non-touchable display screens on which the items of display information with priority “0” (no priority assigned) are displayed are shown as the one or more non-touchable display screens and displayable screens.

Display controller 14 extracts the display information with the lowest priority from among the one or more items of display information displayed on the one or more displayable screens, and causes the candidate information to be displayed on the displayable screen, instead of the extracted display information with the lowest priority.

For example, the display information with priority “4” has the lowest priority, but is displayed on one of the one or more displayable screens in the one or more non-touchable display screens. For this reason, when obtainer 11 obtains candidate information, display controller 14 extracts the display information with the lowest priority “2” from among the one or more items of display information displayed on the one or more touchable display screens and displayable screens, and causes the visibility options to be displayed, instead of the extracted display information with the lowest priority “2”. In (b) in FIG. 14, the temporary storage option is displayed on the touchable display screen in addition to the visibility options by display controller 14. When displaying the candidate information onto display screen 3a is selected in the visibility options, display controller 14 also causes the candidate information to be displayed on the displayable screen in the non-touchable display screen on which the display information with the lowest priority “4” is currently displayed, instead of the display information with the lowest priority “4”, as shown in (c) in FIG. 14.

In addition, display controller 14 causes the end option indicating that the display is to be terminated to be displayed not on the one or more non-touchable display screens, but on the one or more touchable display screens. For example, display controller 14 causes the end option for “End display” to be displayed in a manner that such end option is overlaid on the display information with the lowest priority among the one or more items of display information displayed on the one or more touchable display screens.

### Working Effects

The following describes the working effects achieved by in-vehicle display control device 10, the in-vehicle display control method, and the program according to the present embodiment.

The information controlling device disclosed in PTL 1 fails to provide a solution to the case such as where, when information is newly obtained from outside, whether to display such newly obtained information, and when such obtained information is determined to be displayed, where in the divided regions to display such information. In view of this, it is conceivable that a predetermined location is set as a location at which newly obtained information is always displayed, but there is a risk that information and so forth necessary for the user will be buried. On the other hand, when the obtained information is always displayed in the divided regions, there is a risk that the display will be flooded with information that is not necessary for the user. For this reason, information is required to be presented to the user in a balanced manner so that information necessary for the user will not be buried and information unnecessary for the user will not overwhelm the user.

In view of this, in-vehicle display control device 10 according to Technique 1 of the present embodiment is, as described above, is in-vehicle display control device 10 that controls display device 3 included in vehicle 2, including: obtainer 11 that obtains candidate information that is a candidate for display on display screen 3a of display device 3; and display controller 14 that causes visibility options to be displayed on display screen 3a, and causes the candidate information obtained by obtainer 11 to be displayed on display screen 3a when displaying the candidate information onto display screen 3a is selected in the visibility options, the visibility options being options of displaying or not displaying the candidate information onto display screen 3a.

With this, it is possible to present, to the user, the visibility options of displaying or not displaying the obtained candidate information onto display 3a. This enables the user to determine and select, from such presented visibility options, whether to display the candidate information onto display screen 3a.

According to in-vehicle display control device 10, it is thus possible to present information in a balanced manner for the user to appropriately have a grasp of necessary information.

Also, in-vehicle display control device 10 according to Technique 2 of the present embodiment is in-vehicle display control device 10 according to Technique 1. In this case, display controller 14 further causes a temporary storage option to be displayed on display screen 3a in a manner that the temporary storage option is aligned with the visibility options, the temporary storage option being an option of temporarily storing the candidate information.

With this, it is possible to present, to the user, the temporary storage option of whether to temporarily store the obtained candidate information. This enables the user to determine, from such presented temporary storage option, whether to temporarily store the candidate information.

Also, in-vehicle display control device 10 according to Technique 3 of the present embodiment is in-vehicle display control device 10 according to Technique 2, further including: a storage (first storage 12a) for storing the candidate information obtained by obtainer 11, wherein obtainer 11 sets a flag that takes into account a possibility that the temporary storage option will be selected and stores, in the storage (first storage 12a), the candidate information to which the flag is set, together with the flag.

With this, it is possible to temporarily store, in first storage 12a, the flagged candidate information, together with the flag. This enables the user to view the temporarily stored candidate information.

Also, in-vehicle display control device 10 according to Technique 4 of the present embodiment is in-vehicle display control device 10 according to Technique 3. In this case, the visibility options include: a display option indicating that the candidate information is to be displayed on display screen 3a; and a hide option indicating that the candidate information is not to be displayed on display screen 3a, and display controller 14 invalidates the flag set to the candidate information when one of the display option or the hide option is selected.

With this, it is possible to invalidate the flag set to the candidate information unless the option of temporarily storing the candidate information is selected. This prevents the display of unnecessary candidate information that is not selected to be temporarily stored.

Also, in-vehicle display control device 10 according to Technique 5 of the present embodiment is in-vehicle display control device 10 according to any one of Techniques 1 to 4. In this case, when a plurality of items of display information are displayed on display screen 3a, a priority is assigned to each of the plurality of items of display information, and display controller 14 extracts display information with a lowest priority from among the plurality of items of display information, and causes the visibility options to be displayed in a low-priority region on display screen 3a instead of the display information with the lowest priority extracted.

With this, it is possible to display the visibility options instead of the display information with the lowest priority. This prevents display information with a high priority from being hidden. It is thus possible to enable the user to have a grasp of the display information with a high priority.

Also, in-vehicle display control device 10 according to Technique 6 of the present embodiment is in-vehicle display control device 10 according to Technique 5. In this case, when display controller 14 has caused the visibility options to be displayed in the low-priority region on display screen 3a, display controller 14 further extracts display information with a next lowest priority from among the plurality of items of display information from which the display information with the lowest priority has been extracted, and causes the visibility options to be displayed in a low-priority region, on display screen 3a, in which the display information with the next lowest priority is currently displayed, instead of the display information with the next lowest priority extracted.

With this, when two or more items of candidate information are obtained, it is possible to display the visibility options for the items of display information in descending order of priority. This enables to display, on display screen 3a, the visibility options of displaying or not displaying the two or more items of candidate information.

Also, in-vehicle display control device 10 according to Technique 7 of the present embodiment is in-vehicle display control device 10 according to Technique 5 or 6. In this case, the candidate information includes emergency candidate information indicating emergency and normal candidate information other than the emergency candidate information, and when obtainer 11 obtains the emergency candidate information, display controller 14 causes the emergency candidate information to be displayed in the low-priority region on display screen 3a instead of: the display information with the lowest priority; the visibility options of displaying or not displaying the normal candidate information in the low-priority region on display screen 3a; or the normal candidate information currently displayed in the low-priority region on display screen 3a.

With this, even when the normal candidate information or the visibility options are displayed on display screen 3a, it is possible for display controller 14 to automatically switch the display from the normal candidate information to the emergency candidate information or from the visibility options to the emergency candidate information, when the emergency candidate information is obtained.

This prevents the display information indicating high emergency from being buried, thus enabling the user to have a grasp of the emergency candidate information.

Also, in-vehicle display control device 10 according to Technique 8 of the present embodiment is in-vehicle display control device 10 according to any one of Techniques 5 to 7. In this case, when the plurality of items of display information are displayed on display screen 3a, and the candidate information obtained by obtainer 11 is linked to one display information among the plurality of items of display information, display controller 14 causes the candidate information to be displayed on display screen 3a in a manner that the candidate information is overlaid on the one display information to which the candidate information is linked.

With this, it is possible to display the candidate information in a manner that the candidate information is overlaid on the display information related to such candidate information. This enables the user to simultaneously recognize the display information and the candidate information. The user’s understanding is thus expected to increase.

Also, in-vehicle display control device 10 according to Technique 9 of the present embodiment is in-vehicle display control device 10 according to Technique 8. In this case, the candidate information includes emergency candidate information indicating emergency and normal candidate information other than the emergency candidate information, and when obtainer 11 obtains the emergency candidate information after obtaining the normal candidate information, display controller 14 causes the emergency candidate information to be displayed on display screen 3a instead of the one display information to which the candidate information is linked.

With this, even when the candidate information is displayed in a manner that the candidate information is overlaid on the display information related to such candidate information, it is possible for display controller 14 to automatically switch the display from the candidate information and the display information related to such candidate information to the emergency candidate information, when the emergency candidate information is obtained. This prevents the candidate information indicating high emergency from being buried, thus enabling the user to have a grasp of the emergency candidate information.

Also, in-vehicle display control device 10 according to Technique 10 of the present embodiment is in-vehicle display control device 10 according to Technique 8. In this case, the candidate information includes emergency candidate information indicating emergency and normal candidate information other than the emergency candidate information, and when obtainer 11 obtains the emergency candidate information after obtaining the normal candidate information, display controller 14 extracts the display information with the lowest priority from among the plurality of items of display information, and causes the emergency candidate information to be displayed in the low-priority region on display screen 3a, instead of the display information with the lowest priority extracted.

With this, even when the normal candidate information is currently displayed on display screen 3a, it is possible for display controller 14 to automatically switch the display from the normal candidate information to the emergency candidate information, when the emergency candidate information is obtained, and cause the candidate information to be continuously displayed in a manner that the candidate information is overlaid on the display information related to such candidate information.

This prevents the candidate information indicating high emergency from being buried and enables the user to simultaneously recognize the display information and the candidate information displayed on display screen 3a. It is thus possible for the user to have a grasp of the emergency candidate information, resulting in the expectation that the user’s understanding of the display information and the candidate information increases.

Also, in-vehicle display control device 10 according to Technique 11 of the present embodiment is in-vehicle display control device 10 according to any one of Techniques 8 to 10. In this case, when the displaying the candidate information onto display screen 3a is selected in the visibility options after obtainer 11 obtains the candidate information, display controller 14 causes the candidate information to be displayed on display screen 3a in accordance with the priority assigned to the candidate information.

With this, it is possible to update the priority of the candidate information that is displayed in the low-priority region with the lowest priority to the priority that is assigned in advance to such candidate information. For this reason, when the priority assigned to the obtained candidate information is higher than the priorities assigned to the other items of display information, it is possible to set, as the low-priority region, the display region in which the display information with a lower priority than the priority of the obtained candidate information is displayed and to hide (delete) such display information with a lower priority from display screen 3a.

Further, by updating to the priority assigned to the candidate information, it is possible to prevent the candidate information that is already displayed on display screen 3a from being determined to have the lowest priority and hidden by another candidate information newly obtained. This enables the display of the candidate information with a high priority onto display screen 3a.

Also, in-vehicle display control device 10 according to Technique 12 of the present embodiment is in-vehicle display control device 10 according to any one of Techniques 1 to 11. In this case, when vehicle 2 includes a plurality of display screens 3a of a plurality of display devices 3, the plurality of display screens 3a include one or more touchable display screens having an input function and one or more non-touchable display screens having no input function, the one or more touchable display screens are set to display the visibility options, the one or more non-touchable display screens are set not to display the visibility options, and display controller 14 extracts display information with a lowest priority from among one or more items of display information displayed on the one or more touchable display screens and causes the visibility options to be displayed on the one or more touchable display screens instead of the display information with the lowest priority extracted.

With this, also in vehicle 2 in which both a non-touchable display screen and a touchable display screen are included, the visibility options are displayed on the touchable display screen to enable the user to determine, from such presented visibility options, whether to display the candidate information onto display screen 3a.

Also, when the candidate information is displayed on display screen 3a, it is possible to display such candidate information onto the non-touchable display screen or the touchable display screen on which the display information with the lowest priority is currently displayed.

Also, in-vehicle display control device 10 according to Technique 13 of the present embodiment is in-vehicle display control device 10 according to Technique 12. In this case, display controller 14 causes an end option indicating an end of display to be displayed on the one or more touchable display screens instead of the one or more non-touchable display screens.

With this, it is possible for the user to terminate the display of the candidate information displayed on the non-touchable display screen or the touchable display screen. This reduces the amount of information that is no longer useful for the user to be displayed and prevents the non-touchable display screen and the touchable display screen from being flooded with information.

Also, in-vehicle display control device 10 according to Technique 14 of the present embodiment is in-vehicle display control device 10 according to Technique 12 or 13. In this case, when one or more displayable screens configured to display the candidate information are set out of the one or more touchable display screens and the one or more non-touchable display screens, display controller 14 extracts display information with a lowest priority from among the one or more items of display information displayed on the one or more displayable screens and causes the candidate information to be displayed on the one or more displayable screens instead of the display information with the lowest priority extracted.

With this, it is possible to display the candidate information only within the displayable screen that is set in advance. This enables the candidate information to be displayed within the displayable screen in accordance with the user’s preference.

Also, in-vehicle display control device 10 according to Technique 15 of the present embodiment is in-vehicle display control device 10 according to Technique 2 or 3. In this case, display controller 14 further causes a list option to be displayed on display screen 3a, the list option showing a list of the candidate information temporarily stored.

With this, it is possible to display the list of the items of candidate information that are temporarily stored. This enables the user to easily have a grasp of the list and easily display desired candidate information from the list.

Also, the in-vehicle display control method according to Technique 16 of the present embodiment is an in-vehicle display control method for controlling display device 3 included in vehicle 2, including: (i) obtaining candidate information that is a candidate for display on display screen 3a of display device 3, (i) being performed by obtainer 11; and (ii) causing visibility options to be displayed on display screen 3a and (iii) causing the candidate information obtained by obtainer 11 to be displayed on display screen 3a when displaying the candidate information onto display screen 3a is selected in the visibility options, the visibility options being options of displaying or not displaying the candidate information onto display screen 3a, (ii) and (iii) being performed by display controller 14.

The above method also achieves the same working effects as those described above.

Also, the program according to Technique 17 of the present embodiment is a program for use in a computer to execute the in-vehicle display control method according to Technique 16.

The above program also achieves the same working effects as those described above.

### Other Variations

The in-vehicle display control device, the in-vehicle display control method, and the program according to the present disclosure have been described above on the basis of the foregoing embodiment, but the present disclosure is not limited to such embodiment. The scope of the present disclosure also includes an embodiment achieved by making various modifications to the embodiment that can be conceived by those skilled in the art without departing from the essence of the present disclosure.

For example, in the in-vehicle display control device and so forth according to the foregoing embodiment, the selection by the user is not limited to being performed from the options displayed on the display screen. The selection by the user may thus be performed, for example, by the user by means of voice input or using, for example, an external terminal not included in the vehicle, such as a smartphone, a table terminal, etc.

Also, in the in-vehicle display control device and so forth according to the foregoing embodiment, the display controller may cause the message “Storage completed” to be displayed on the display screen when “Temporarily store” is selected.

Also, in the in-vehicle display control device and so forth according to the foregoing embodiment, the display controller may cause information to be displayed without displaying the foregoing options depending on the type of information, as in the case of emergency candidate information. The display controller may also determine whether to display the visibility options in the low-priority region on the display screen in accordance with the type of candidate information obtained.

Also, in the in-vehicle display control device and so forth according to the foregoing embodiment, when candidate information is currently displayed, external information from the information communication device may be blocked to prevent new candidate information from being displayed. In blocking the external information, the external information may be discarded or may be stored onto the first storage as candidate information. Then, after the display of the currently displayed candidate information is terminated, an input of the external information may be permitted and the display of the options on the display screen may be permitted. Alternatively, in the in-vehicle display control device and so forth according to the foregoing embodiment, when candidate information is currently displayed, the external information may be stored onto the first storage to prevent new candidate information from being displayed. Then, after the display of the currently displayed candidate information is terminated, the next candidate information may be obtained from the first storage and the display of the options on the display screen may be permitted.

The elements included in the in-vehicle display control device according to the foregoing embodiment, such as the display controller, is realized in the form of a large-scale integration (LSI), which is typically an integrated circuit. These elements may take the form of individual chips, or may be encapsulated into a single chip to embrace some or all of the elements.

The method of circuit integration is not limited to be in the form of LSI, and thus may be realized in the form of a dedicated circuit or a general-purpose processor. A Field Programmable Gate Array (FPGA) that allows for programming after the manufacture of an LSI, or a reconfigurable processor that allows for reconfiguration of the connection and the settings of circuit cells inside an LSI may be employed.

Each of the elements in the foregoing embodiment may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

Also, all of the numerics in the above description are used as examples to specifically describe the present disclosure, and thus the embodiment of the present disclosure is not limited to such numerics provided as examples.

Also, the division of the functional blocks in the block diagram is an example, and thus a plurality of functional blocks may be realized in the form of a single functional block, a single functional block may be divided into a plurality of blocks, and some of the functions may be moved to another functional block. Also, the functions of a plurality of functional blocks having similar functions may be processed by single hardware or software in parallel or in a time-shared manner.

Also, the order of executing the steps in the flowchart is an example to specifically describe the present disclosure, and thus other orders may be used. Also, some of the steps may be executed simultaneously (parallelly) with other steps.

Note that the present disclosure also includes an embodiment achieved by making various modifications to the foregoing embodiment that can be conceived by those skilled in the art and an embodiment achieved by freely combining elements and functions in the foregoing embodiment without departing from the essence of the present disclosure.

While an exemplary embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-199920 filed on November 15, 2024.

### INDUSTRIAL APPLICABILITY

The in-vehicle display control device, the in-vehicle display control method, and the program of the present disclosure are applicable for use in vehicles in which one or more display devices are included.

1. An in-vehicle display control device that controls a display device included in a vehicle, the in-vehicle display control device comprising: an obtainer that obtains candidate information that is a candidate for display on a display screen of the display device; and a display controller that causes visibility options to be displayed on the display screen, and causes the candidate information obtained by the obtainer to be displayed on the display screen when displaying the candidate information onto the display screen is selected in the visibility options, the visibility options being options of displaying or not displaying the candidate information onto the display screen.

2. The in-vehicle display control device according to claim 1, wherein the display controller further causes a temporary storage option to be displayed on the display screen in a manner that the temporary storage option is aligned with the visibility options, the temporary storage option being an option of temporarily storing the candidate information.

3. The in-vehicle display control device according to claim 2, further comprising: a storage for storing the candidate information obtained by the obtainer, wherein the obtainer sets a flag that takes into account a possibility that the temporary storage option will be selected and stores, in the storage, the candidate information to which the flag is set, together with the flag.

4. The in-vehicle display control device according to claim 3, wherein the visibility options include: a display option indicating that the candidate information is to be displayed on the display screen; and a hide option indicating that the candidate information is not to be displayed on the display screen, and the display controller invalidates the flag set to the candidate information when one of the display option or the hide option is selected.

5. The in-vehicle display control device according to claim 1, wherein when a plurality of items of display information are displayed on the display screen, a priority is assigned to each of the plurality of items of display information, andthe display controller extracts display information with a lowest priority from among the plurality of items of display information, and causes the visibility options to be displayed in a low-priority region on the display screen instead of the display information with the lowest priority extracted.

6. The in-vehicle display control device according to claim 5, wherein when the display controller has caused the visibility options to be displayed in the low-priority region on the display screen,the display controller further extracts display information with a next lowest priority from among the plurality of items of display information from which the display information with the lowest priority has been extracted, and causes the visibility options to be displayed in a low-priority region, on the display screen, in which the display information with the next lowest priority is currently displayed, instead of the display information with the next lowest priority extracted.

7. The in-vehicle display control device according to claim 5, wherein the candidate information includes emergency candidate information indicating emergency and normal candidate information other than the emergency candidate information, and when the obtainer obtains the emergency candidate information, the display controller causes the emergency candidate information to be displayed in the low-priority region on the display screen instead of: the display information with the lowest priority; the visibility options of displaying or not displaying the normal candidate information in the low-priority region on the display screen; or the normal candidate information currently displayed in the low-priority region on the display screen.

8. The in-vehicle display control device according to claim 5, wherein when the plurality of items of display information are displayed on the display screen, and the candidate information obtained by the obtainer is linked to one display information among the plurality of items of display information, the display controller causes the candidate information to be displayed on the display screen in a manner that the candidate information is overlaid on the one display information to which the candidate information is linked.

9. The in-vehicle display control device according to claim 8, wherein the candidate information includes emergency candidate information indicating emergency and normal candidate information other than the emergency candidate information, andwhen the obtainer obtains the emergency candidate information after obtaining the normal candidate information, the display controller causes the emergency candidate information to be displayed on the display screen instead of the one display information to which the candidate information is linked.

10. The in-vehicle display control device according to claim 8, wherein the candidate information includes emergency candidate information indicating emergency and normal candidate information other than the emergency candidate information, and when the obtainer obtains the emergency candidate information after obtaining the normal candidate information, the display controller extracts the display information with the lowest priority from among the plurality of items of display information, and causes the emergency candidate information to be displayed in the low-priority region on the display screen, instead of the display information with the lowest priority extracted.

11. The in-vehicle display control device according to claim 8, wherein when the displaying the candidate information onto the display screen is selected in the visibility options after the obtainer obtains the candidate information, the display controller causes the candidate information to be displayed on the display screen in accordance with the priority assigned to the candidate information.

12. The in-vehicle display control device according to claim 1, wherein when the vehicle includes a plurality of display screens of a plurality of display devices, the plurality of display screens include one or more touchable display screens having an input function and one or more non-touchable display screens having no input function, the plurality of display screens each being the display screen, the plurality of display devices each being the display device,the one or more touchable display screens are set to display the visibility options,the one or more non-touchable display screens are set not to display the visibility options, andthe display controller extracts display information with a lowest priority from among one or more items of display information displayed on the one or more touchable display screens and causes the visibility options to be displayed on the one or more touchable display screens instead of the display information with the lowest priority extracted.

13. The in-vehicle display control device according to claim 12, wherein the display controller causes an end option indicating an end of display to be displayed on the one or more touchable display screens instead of the one or more non-touchable display screens.

14. The in-vehicle display control device according to claim 12, wherein when one or more displayable screens configured to display the candidate information are set out of the one or more touchable display screens and the one or more non-touchable display screens,the display controller extracts display information with a lowest priority from among the one or more items of display information displayed on the one or more displayable screens and causes the candidate information to be displayed on the one or more displayable screens instead of the display information with the lowest priority extracted.

15. The in-vehicle display control device according to claim 2, wherein the display controller further causes a list option to be displayed on the display screen, the list option showing a list of the candidate information temporarily stored.

16. An in-vehicle display control method of controlling a display device included in a vehicle, the in-vehicle display control method comprising:(i) obtaining candidate information that is a candidate for display on a display screen of the display device, (i) being performed by an obtainer; and(ii) causing visibility options to be displayed on the display screen and (iii) causing the candidate information obtained by the obtainer to be displayed on the display screen when displaying the candidate information onto the display screen is selected in the visibility options, the visibility options being options of displaying or not displaying the candidate information onto the display screen, (ii) and (iii) being performed by a display controller.

17. A non-transitory computer-readable recording medium having recorded thereon a program for causing a computer to execute the in-vehicle display control method according to claim 16.
